(19) United States
(12) Patent Application Publication
(10) Pub. No.: US 2009/0101263 A1
(43) Pub. Date: Apr. 23, 2009

(54) Pneumatic Tire

(75) Inventor: Norihiko Nakamura, Osaka (JP)

Correspondence Address: FISH & RICHARDSON P.C., P.O. BOX 1022, MINNEAPOLIS, MN, 55440-1022, US

(73) Assignee: Toyo Tire & Rubber Co., Ltd.

(21) Appl. No.: 12/248,101

(22) Filed: Oct. 9, 2008

(30) Foreign Application Priority Data
Oct. 18, 2007 (JP) 2007-271088

(51) Int. Cl. B60C 3/00

(52) U.S. Cl. 152/454

(57) ABSTRACT

A pneumatic tire with excellent run-flat performance that can improve durability of a tire and promote low fuel comsuption is provided. The pneumatic tire has a reinforcing rubber layer with a nearly crescent cross section at the inner side of a carcass layer of a side wall, wherein the reinforcing rubber layer comprises a rubber composition which comprises 100 parts by weight of a diene rubber component containing from 15 to 50 parts by weight of a butadiene rubber or a styrene-butadiene rubber, its molecular end being modified with a modifier, polymerized using an organic lithium catalyst, and from 40 to 80 parts by weight of carbon black having a nitrogen adsorption specific surface area (N₂SA) of from 20 to less than 30 m²/g and a dibutyl phthalate (DBP) absorption of from 50 to 155 cm³/100 g, and loss tangent (tan δ) of the rubber composition measured at 70° C. is less than 0.07.

### CROSS-REFERENCE TO RELATED APPLICATIONS

This application is based upon and claims the benefit of priority from the prior Japanese Patent Application No. 2007-271088, filed on Oct. 18, 2007; the entire contents of which are incorporated herein by reference.

### BACKGROUND

The present invention relates to a pneumatic tire with run-flat performance, having a reinforcing rubber layer at a side wall.

A tire called a run-flat tire that can run a certain distance even in the case that air pressure in the inside of a tire is decreased by failure such as puncture and has reached zero is developed. As one of tire structure for enabling such a run-flat running, a tire in which an inner face of a side wall is reinforced with a reinforcing rubber layer is known.

The reinforcing rubber layer is required to have durability at run-flat running. Therefore, a rubber layer having relatively high hardness and having a large cross sectional width with a nearly crescent cross section is used, but further improvement of durability is required.

Furthermore, there are the problems that when the amount of the reinforcing rubber layer used is increased, weight of a tire is increased, thereby increasing rolling resistance and deteriorating fuel consumption, and ride quality at the time of usual running is impaired as hardness becomes higher.

As means for improving durability of run-flat tire, a method of increasing vulcanization density by using a large amount of a vulcanizing agent and a vulcanization accelerator without increasing an amount of carbon black (US 2002/0091184 A1), the entire contents of this reference being incorporated herein by reference), a rubber composition for tire comprising a rubber component containing a star-shaped solution polymerization butadiene rubber, a specific carbon black and a vulcanizing agent (US 2005/0209393 A1), the entire contents of this reference being incorporated herein by reference), and the like are proposed. However, it does not say that those techniques are sufficient for the required level of durability and low fuel consumption.

### SUMMARY

In view of the above problems related to a run-flat tire, according to the aspect of the present invention, there is provided a pneumatic tire with excellent run-flat performance in which a rubber composition that can improve durability of a tire, reduce rolling resistance and promote low fuel consumption is used in a reinforcing rubber layer of a side wall.

The present invention may provide a pneumatic tire having a reinforcing rubber layer with a nearly crescent cross section at the inner side of a carcass layer of a side wall, wherein the reinforcing rubber layer comprises a rubber composition which comprises 100 parts by weight of a diene rubber component containing from 15 to 50 parts by weight of a butadiene rubber or a styrene-butadiene rubber, its molecular end being modified with a modifier, polymerized using an organic lithium catalyst, and from 40 to 80 parts by weight of carbon black having a nitrogen adsorption specific surface area (N₂SA) of from 20 to less than 30 m²/g and a dibutyl phthalate (DBP) absorption of from 50 to 155 cm³/100 g, and loss tangent (tan δ) of the rubber composition measured at 70° C. is less than 0.07.

According to the pneumatic tire of the aspect of the present invention, durability at the time of run-flat running is improved, and additionally rolling resistance of a tire can be reduced, thereby improving low fuel consumption at the time of usual running.

### BRIEF DESCRIPTION OF THE DRAWINGS

FIG. 1 is a half sectional view showing one example of a pneumatic tire of the embodiments.

### DETAILED DESCRIPTION

The embodiments of the present invention are described below.

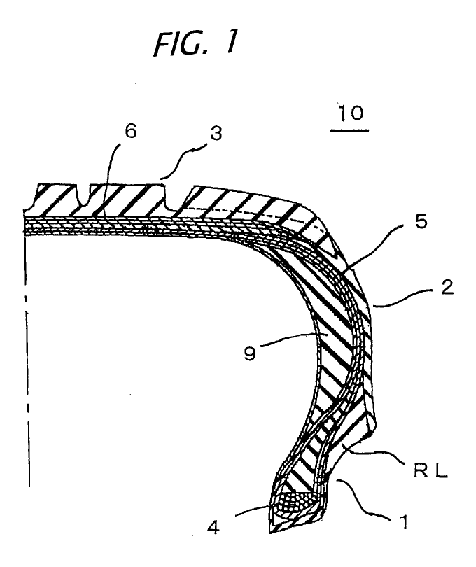

FIG. 1 is a half sectional view showing one example of a pneumatic tire according to the embodiments of the present invention. As shown in the drawing, a pneumatic tire 10 comprises a carcass layer 5 turned around a bead core 4 in a bead 1, a belt layer 6 reinforcing the carcass layer 5 in a tread 3, and a side reinforcing rubber layer 9 showing a nearly crescent shape in a meridian cross section of a tire at the inner face side of the carcass layer 5 and reinforcing a side wall 2. In the embodiment shown in the drawing, the carcass layer 5 is one ply.

The side reinforcing rubber layer 9 is provided over a region of from the vicinity of a rim line RL contacting the upper edge of a rim flange at the time of run-flat to the edge of the belt layer 6 in the inside of the carcass layer 9, with a nearly crescent shape in the cross section including a tire axis.

The rubber composition used in the side reinforcing rubber layer 9 is that as the rubber component, a modified diene rubber having a molecular end modified with a modifier, which is a butadiene rubber (BR) or a styrene-butadiene rubber (SBR) polymerized using an organic lithium catalyst is used in an amount of from 15 to 50 parts by weight in the rubber component, and other diene rubber other than the modified diene rubber is used as a remainder of the rubber component.

The organic lithium compound used as a polymerization catalyst of the modified diene rubber is an organic lithium compound generally used in a solution polymerization, and its kind is not particularly limited. Examples of the organic lithium compound include alkyl lithium represented by methyl lithium, ethyl lithium, propyl lithium, n-butyl lithium, sec-butyl lithium, tert-butyl lithium, n-hexyl lithium or n-octyl lithium; aryl lithium represented by phenyl lithium, tolyl lithium or lithium naphthylide; alkenyl lithium represented by vinyl lithium or propenyl lithium; and alkylene dilithium represented by tetramethylene dilithium, pentamethylene dilithium, hexamethylene dilithium or decamethylene dilithium.

The modified diene rubber is that a molecular end thereof is modified with a modifier. Examples of the modifier include a tin compound, and a compound containing a hydroxyl group, an amino group, an epoxy group, a cyano group, a carboxyl group, a halogen, an alkoxy group or the like. In the modified diene rubber, a tin compound, a hydroxyl group, an amino group, an epoxy group, a cyano group, a carboxyl group, a halogen atom, an alkoxy group or the like is introduced into a polymer end of the diene rubber by modification. The degree of modification is 20% or more, and preferably 40% or more. The preferred modifier is a tin compound, a hydroxyl group-containing compound or an amino group-containing compound.

Examples of the tin compound include tin halide compounds such as tin tetrachloride, tin methyl trichloride, dibutyldichlorotin or tributylchlorotin; allyl tin compounds such as tetraallyltin, diethyldiallyltin or tetra(2-octenyl)tin; tetraphenyltin and tetrabenzyltin.

The compounding amount of the end-modified polymer is from 15 to 50 parts by weight per 100 parts by weight of the rubber component. Where the compounding amount is less than 15 parts by weight, an effect of improving affinity with a reinforcing agent is not obtained, and an effect of reducing rolling resistance is small, and where the compounding amount exceeds 50 parts by weight, a Mooney viscosity tends to rise and processability tends to deteriorate.

Polymerization method and end modification method of the polymer can be conducted according to the conventional methods, and the methods described in, for example, JP-A-2002-284930 (kokai) and JP-A-2002-284933 (kokai), the entire contents of those references being incorporated herein by reference, can be used.

The other diene rubber is not particularly limited, and examples thereof include a natural rubber, and a synthetic diene rubber such as an isoprene rubber and a butadiene rubber or a styrene-butadiene rubber other than the above modified diene rubber, which are polymerized by a solution polymerization or an emulsion polymerization. Those may be used alone or as mixtures of two or more thereof, as the rubber component.

The rubber composition used in the side reinforcing rubber layer comprises 100 parts by weight of a rubber component comprising a blend of the modified diene rubber and other diene rubber, and from 40 to 80 parts by weight of carbon black having a nitrogen adsorption specific surface area (N₂SA) of from 20 to less than 30 m²/g and a dibutyl phthalate (DBP) absorption of from 50 to 155 cm³/100 g.

Where the N₂SA of the carbon black is less than 20 m²/g, durability deteriorates due to insufficient strength of the rubber composition. On the other hand, where the N₂SA is 30 m²/g or more, hysteresis loss is increased, and as a result, rolling resistance and generation of heat are increased. Furthermore, where the DBP absorption is less than 50 cm³/100 g, durability is insufficient due to deficiency in strength. On the other hand where the DBP absorption exceeds 155 cm³/100 g, rolling resistance is not improved. The N₂SA and the DBP absorption are values measured according to JIS K6217.

The compounding amount of the carbon black is from 40 to 80 parts by weight per 100 parts by weight of the rubber component. Where the compounding amount of the carbon black is less than 40 parts by weight, reinforcement effect and rubber hardness are deficient and durability deteriorates. On the other hand, where the compounding amount of the carbon black exceeds 80 parts by weight, heat build-up deteriorates, and an effect of reducing rolling resistance is not obtained. Furthermore, productivity tends to be decreased due to deterioration of processability.

Other than the components described above, various additives generally used in a rubber composition for tire, such as inorganic fillers (such as silica), age resisters, zinc white, stearic acid, softeners, vulcanizing agents or vulcanization accelerators can be used in the rubber composition according to the aspect of the present invention in a range that the advantage of the present invention is not impaired.

The rubber composition by the above constitution has a loss factor (tan δ) of less than 0.07 measured at an initial strain of 10%, a dynamic strain of 2%, a frequency of 10 Hz and a temperature of 70° C. according to JIS K-6394.

Where tan δ is 0.07 or more, energy loss is increased, and an effect of reducing rolling resistance is not achieved. The lower limit of tan δ is not particularly limited, but it is preferred to be 0.03 or more.

The rubber composition comprising the above each component is prepared using a kneading machine for rubber, such as Banbury mixer or a kneader, by the conventional methods.

The pneumatic tire according to the aspect of the present invention can improve durability at the time of run-flat and reduce rolling resistance of a tire, thereby improving low fuel consumption of a pneumatic tire, by applying the rubber composition described above to a side reinforcing rubber layer of a pneumatic tire.

### EXAMPLES

The examples of the present invention are specifically described below, but the invention is not limited to those examples.

30 parts by weight of a natural rubber (RSS#3) and each of butadiene rubbers (BR1 to BR3) shown below as rubber components (total 100 parts by weight), each carbon black (CB1 to CB5) shown below, and the common components in each rubber composition were kneaded by the conventional method using Banbury mixer having a volume of 200 liters to prepare a rubber composition of each of Examples and Comparative Examples. The rubber component, carbon black and common compounding components used are as follows.

### Rubber Component

Natural rubber (NR): RSS#3, made in Thailand

Butadiene rubber (BR1): BR01, manufactured by JSR Corporation

Tin-modified butadiene rubber (BR2): BR1250H, manufactured by Nippon Zeon Co., Ltd.

Hydroxyl-modified butadiene rubber (BR3): TUFDENE E40, manufactured by Asahi Kasei Corporation

### Carbon Black

Carbon black (CB1): SEAST SO (N₂SA=42 m²/g, DBP absorption=115 cm³/100 g), manufactured by Tokai Carbon Co., Ltd.

Carbon black (CB2): SEAST V (N₂SA=23 m²/g, DBP absorption=51 cm³/100 g), manufactured by Tokai Carbon Co., Ltd.

Carbon black (CB3): SEAST FY (N₂SA=29 m²/g, DBP absorption=152 cm³/100 g), manufactured by Tokai Carbon Co., Ltd.

Carbon black (CB4): SEAST TA (N₂SA=19 m²/g, DBP absorption=42 cm³/100 g), manufactured by Tokai Carbon Co., Ltd.

Carbon black (CB5) SEAST SVH (N₂SA=32 m²/g, DBP absorption=140 cm³/100 g), manufactured by Tokai Carbon Co., Ltd.

### Common Component

2 parts by weight of an age resister (NOCLAC 6C, manufactured by Ouchi Shinko Chemical Industrial Co., Ltd.), 2 parts by weight of stearic acid (RUNAX S-20, manufactured by Kao Corporation), 3 parts by weight of zinc white (Zinc White #1, manufactured by Mitsui Mining & Smelting Co., Ltd.), 3 parts by weight of sulfur (5% oil-treated powdery sulfur, manufactured by Hosoi Chemical Industry Co., Ltd.), and 1.5 parts by weight of a vulcanization accelerator (NOCCELLAR NS-P, manufactured by Ouchi Shinko Chemical Industrial Co., Ltd.) were compounded and used as the common components in each rubber composition.

Regarding the rubber compositions obtained, a Mooney viscosity as a processability, loss factor (tan δ) and durability of a tire were evaluated by the following methods. The results obtained are shown in Table 1.

### Processability (Mooney Viscosity)

Mooney viscosity (ML₁₊₄) at 100° C. was measured according to JIS K6300, and indicated by an index as Comparative Example 1 being 100. The processability is better as the value is smaller.

### Loss Factor (tan δ)

Using rheospectometer E4000, manufactured by UBM, dynamic modulus tan δ was measured under the conditions of an initial strain of 10%, a dynamic strain of 2%, a frequency of 10 Hz and a temperature of 70° C. according to JIS K-6394. The rolling resistance is better as the value is smaller.

### Tire Durability

A pneumatic tire (run-flat tire) having a structure shown in FIG. 1 and having a tire size of 225/45ZR18 was produced by the conventional method, and ran on a steel drum having a diameter of 1,707 mm at a speed of 80 km/hr under an air pressure of 0 kPa and a load of 4.0 kN until failure occurs in the tire. The durability was indicated by an index as running distance of Comparative Example 1 being 100. The durability is better as the value is larger.

TABLE 1

| | | | | Comparative | Comparative | Comparative | Comparative | Comparative |
|---|---|---|---|---|---|---|---|---|
| | Example 1 | Example 2 | Example 3 | Example 1 | Example 2 | Example 3 | Example 4 | Example 5 |
| NR | 30 | 30 | 30 | 30 | 30 | 30 | 30 | 30 |
| BR1 | 35 | 35 | 35 | 70 | 35 | 70 | 35 | |
| BR2 | 35 | | 35 | | 35 | | 35 | 70 |
| BR3 | | 35 | | | | | | |
| CB1 | | | | 50 | 50 | | | 50 |
| CB2 | 50 | 50 | | | | | | |
| CB3 | | | 50 | | | | | |
| CB4 | | | | | | 50 | | |
| CB5 | | | | | | | 50 | |
| Mooney viscosity | 100 | 90 | 100 | 100 | 115 | 80 | 105 | 130 |
| (Index) | | | | | | | | |
| tan δ | 0.06 | 0.06 | 0.05 | 0.10 | 0.08 | 0.07 | 0.06 | 0.07 |
| Tire durability | 110 | 110 | 110 | 100 | 110 | 80 | 105 | 115 |
| (Index) | | | | | | | | |

The pneumatic tire according to the aspect of the present invention has excellent durability and low fuel consumption and is preferred as a run-flat tire for passenger cars.

What is claimed is:

1. A pneumatic tire having a reinforcing rubber layer with a nearly crescent cross section at the inner side of a carcass layer of a side wall,
wherein the reinforcing rubber layer comprises a rubber composition which comprises 100 parts by weight of a diene rubber component containing from 15 to 50 parts by weight of a butadiene rubber or a styrene-butadiene rubber, its molecular end being modified with a modifier, polymerized using an organic lithium catalyst, and from 40 to 80 parts by weight of carbon black having a nitrogen adsorption specific surface area (N₂SA) of from 20 to less than 30 m²/g and a dibutyl phthalate (DBP) absorption of from 50 to 155 cm³/100 g, and
loss tangent (tan δ) of the rubber composition measured at 70° C. is less than 0.07.

2. The pneumatic tire as claimed in claim 1, wherein the modifier comprises at least one selected from a group consisting of a tin compound, a hydroxyl group-containing compound and an amino group-containing compound.
